(19) United States
(12) Patent Application Publication
(10) Pub. No.: US 2026/0258689 A1
(43) Pub. Date: Sep. 3, 2026

(54) DOOR DRIVE DEVICE COMPRISING A SLIDE ELEMENT

(71) Applicant: Brose Fahrzeugteile SE & Co. KG, Bamberg, Bamberg (DE)

(72) Inventors: Daniel SCHNAPP, Ebensfeld (DE); Tobias GAGEL, Zapfendorf (DE); Uwe SCHILLING, Coburg (DE)

(21) Appl. No.: 19/180,901

(22) Filed: Apr. 16, 2025

(30) Foreign Application Priority Data
Apr. 19, 2024 (DE) 10 2024 111 087.2

(51) Int. Cl. E05F 15/622

(52) U.S. Cl. CPC E05F 15/622; E05Y 2201/624; E05Y 2201/684; E05Y 2201/708; E05Y 2900/531

(57) ABSTRACT

It is provided a door drive device for adjusting a vehicle door relative to a vehicle body, comprising an adjustment part for force transmission between the vehicle door and the vehicle body, a drive motor, and a transmission module that couples the drive motor to the adjustment part. The transmission module comprises at least one guide element and a slide element which is coupled to the adjustment part and is guided along an adjustment direction, on the guide element, and via which the drive motor is adjustable. For example, it is provided that the slide element is formed with a structural part made of fiber-reinforced plastics material.

### CROSS REFERENCE TO RELATED APPLICATIONS

The present application claims priority to German Patent Application No. 10 2024 111 087.2 filed on Apr. 19, 2024. The entire contents of the above-listed application are hereby incorporated by reference for all purposes.

### BACKGROUND

The proposed solution relates to a door drive device for adjusting a vehicle door relative to a vehicle body.

A proposed door drive device comprises an adjustment part for force transmission between the vehicle door and the vehicle body and a drive motor which is coupled to the adjustment part via a transmission module. As is disclosed for example in DE 10 2019 211 932 A1, in the case of a door drive device of this kind the drive motor can for example be arranged on the side of the vehicle door. The adjustment part is coupled to the vehicle body and furthermore operatively connected to the drive motor in such a way that the adjustment part can be adjusted via the drive motor and thereby a force can be brought about between the vehicle door and the vehicle body for the external force-actuated adjustment of the vehicle door relative to the vehicle body. In principle, the drive motor can also be arranged in a fixed manner on the side of the vehicle body, and the adjustment part can be coupled to the vehicle door.

In the case of the door drive device known from DE 10 2019 211 932 A1, the transmission module comprises at least one guide element, for example in the form of a guide rail, and a slide element which is coupled to the adjustment part and is guided on the guide element along an adjustment direction and is adjustable via the drive motor. In DE 10 2019 211 932 A1, the slide element is formed with a metal structural part, in the form of what is known as an insert. The metal structural part is overmolded with plastics material, in order to form slide regions of the slide element, via which the slide element rests on the guide element in a sliding manner. A spindle portion of the slide element is also completely molded, here, from plastics material. A spindle nut thread is formed in the spindle nut portion, for meshing with a drive spindle of the transmission module, in order to adjust the slide element along the adjustment direction.

### SUMMARY

The object of the proposed solution is to further improve a door drive device of this kind, in particular in view of the shaping of the slide element and/or its attachment to the adjustment part.

Against this background, the proposed solution provides a door drive device for adjusting a vehicle door relative to a vehicle body, which comprises an adjustment part for force transmission between the vehicle door and the vehicle body, a drive motor, and a transmission module that couples the drive motor to the adjustment part. The transmission module comprises at least one guide element and a slide element which is coupled to the adjustment part and is guided along on the guide element along an adjustment direction and is adjustable via the drive motor. In addition, it is furthermore provided that the slide element is formed with a structural part made of fiber-reinforced, for example glass fiber-reinforced, plastics material, and
a) at least one slide region for sliding contact on the guide element is arranged on the structural part, which slide region is formed of a material that is different from the fiber-reinforced plastics material of the structural part, and/or
b) a spindle nut portion having a spindle nut thread for meshing with a drive spindle of the transmission module (or for meshing with an external thread of the drive spindle) is formed on the structural part, and a material different from the fiber-reinforced plastics material of the structural part is arranged on the spindle nut thread.

The proposed solution thus in particular proceeds from the basic concept of providing a two-component slide element in which a structuring hard component, which also absorbs loads occurring on the slide element during operation of the door drive device, is manufactured, in the form of the structural part, from fiber-reinforced plastics material (e.g. consists of fiber-reinforced plastics material), and at least one slide region and/or a coating of a spindle nut thread is formed with a material different from the fiber-reinforced plastics material. Configuring the hard component with a fiber-reinforced plastics material allows for significantly cheaper production compared, for example, with a slide element which is produced with a steel insert. Furthermore, the use of fiber-reinforced plastics material for the hard component provides a greater design freedom. Moreover, smaller tolerances can be achieved. Since for example only the at least one slide region and/or an additional, friction-reducing material application on the spindle nut thread is formed from a different material, having tribologically better properties than the fiber-reinforced plastics material of the structural part, the costs for this typically more expensive material can be reduced.

For example, the fiber-reinforced plastics material may be a fiber-reinforced, e.g., glass fiber-reinforced, thermoplastic, which may be fiber-reinforced, optionally glass fiber-reinforced, polyamide. The material for the at least one slide region and/or the material attached to the spindle nut thread can for example be polyoxymethylene (POM) or polyamide (PA) or another material having better tribological properties-at least in interaction with the at least one guide element in the case of a slide region, and/or in conjunction with an external thread of the drive spindle in the case of the spindle nut thread.

The at least one slide region can be injected or fastened onto the structural part formed of fiber-reinforced plastics material, in the latter case for example can be clipped onto the structural part.

Alternatively, or in addition, the preferably friction-reducing material, for example POM, can be injected onto the spindle nut thread which is formed by the fiber-reinforced plastics material of the structural part. Since for example POM is used merely for overmolding the spindle nut thread, and the spindle nut thread itself is formed by the fiber-reinforced plastics material, the toothing on the spindle nut portion can be configured having comparatively high rigidity, and the use of costly POM can be kept low. In this case, however, even a thin-walled POM layer on the spindle nut thread significantly reduces the friction occurring during operation.

In a variant, the at least one slide region is arranged on a base portion of the structural part, and the same material is provided both for forming the at least one slide region and for arrangement on the spindle nut thread. In order to further simplify the production process in the case of such a variant, at least one connecting channel can be formed in the structural part, via which, during production of the at least one slide region, the then still liquid material (for example POM) can flow onto the spindle nut thread, or via which the then still liquid material can flow to the base portion, upon arrangement of the material on the spindle nut thread, for forming the at least one slide region, in order to form the slide region at said base portion. Thus, within a die for the production of the slide element, during the production process the material which is to be injected onto the spindle nut thread and forms the slide regions can flow via the at least one connecting channel in the structural part from the spindle nut portion to the base portion, or vice versa from the base portion to the spindle nut portion. The at least one connecting channel formed in the structural part is therefore provided such that during a production process for manufacturing the slide element, the material which is to be injected onto the spindle nut thread and forms the at least one slide region can flow via the at least one connecting channel in the structural part from the spindle nut portion to the base portion, or vice versa from the base portion to the spindle nut portion.

In a variant, the structural part of the slide element comprises an end stop surface which strikes a mating element of the door drive device at the end of an adjustment path for the vehicle door and is convexly curved in the direction of the mating element. The mating element is a component relative to which the adjustment part, and consequently the slide element coupled to the adjustment part, is adjustable. Consequently, the adjustment path of the vehicle door is limited, for example in an opening direction, by the stop of the slide element, with its end stop surface on the mating element. In this case, higher loads can be transmitted via a convexly configured end stop surface. In particular, a convex curvature of the end stop surface makes it possible to ensure, upon striking, a contact of the slide element on the mating element that is favorable in terms of stress. In this case, a convex curvature at the end stop surface of the slide element can also be formed significantly more easily with in tight tolerances, when the structural part is formed of fiber-reinforced plastics material.

Alternatively, or in addition, a mating surface of the mating element can be configured to be convexly curved in the direction of the slide element.

According to a further aspect of the proposed solution, which can be readily combined with the aspects mentioned above, a door drive device is provided for adjusting a vehicle door relative to a vehicle body, with a slide element that comprises a base portion, on which a connection region for coupling the adjustment part to the slide element is formed and on which at least one fastening opening for a connection element is formed. In this case, the adjustment part, which is coupled to the drive motor of the door drive device via the transmission module, is fixed on the slide element via the connection element, in that the connection element engages through a through-opening on the adjustment part, transversely to the adjustment direction of the slide element. In turn, at the at least one fastening opening a fixing insert is received in the base portion of the slide element in a form-fitting and/or force-fitting manner via a press fit, which fixing insert comprises a fixing opening in which a portion of the connection element is fixed.

Therefore, according to this aspect of the proposed solution, a separate fixing insert is received in a form-fitting and/or force-fitting manner in the base portion of the slide element (which can for example be formed by the structural part, explained above, made of fiber-reinforced plastics material), via which fixing insert a connection element is fixed on the slide element, via which the adjustment part is fixed on the slide element, e.g., hinged to the slide element. In this case, the fixing insert can for example be embedded in the material of the base portion, in particular may have been injection molded by said material during production of the base portion, such that the fixing insert is received inside the base portion in a form-fitting manner and is held therein without play. The connection element, for example in the form of a connecting bolt pressed in transversely to the adjustment direction, can be fixed to the slide element in a more easily defined manner, via the fixing insert, and can thus ensure that forces are absorbed by the adjustment part, via the fixing insert, and introduced into the base portion.

In a variant, the connection element and the fixing insert are secured on the base portion in a form-fitting manner in opposite directions along an axis extending through the fastening opening. Thus, in this case, the connection element can be secured e.g. downwards, in a form-fitting manner, by the base portion, while the fixing insert is secured upwards, in a form-fitting manner, by the base portion.

In particular, the fixing insert can be overmolded with fiber-reinforced plastics material during production of the slide element, such that the fixing insert is completely enclosed by the fiber-reinforced plastics material of the base portion along a peripheral direction, abut an axis extending transversely to the later adjustment direction of the slide element. The fixing insert is consequently laid in a production die, during production of the slide element and in particular its base portion, and overmolded with fiber-reinforced plastics material. The fixing insert can for example be configured consisting of metal, and thus as a metal insert part.

For establishing a form-fitting connection with the base portion, the fixing insert can comprise at least one projection which protrudes radially towards the outside with respect to an axis extending transversely to the adjustment direction (and thus for example with respect to a central axis of the fixing opening), and thus protrudes into the material of the base portion. In principle, a plurality of projections that are distributed over an outer periphery of the fixing insert and protrude radially in each case can also be provided, via which projections a form-fitting connection with the base portion is formed in each case. A connection between the fixing insert and the material of the base portion can be reinforced via a plurality of (at least two) projections.

In a variant, the base portion of the slide element comprises a further fastening opening, in addition to the fastening opening that receives the fixing insert, in which further fastening opening a further portion of the connection element is received in a form-fitting and/or force-fitting manner. Thus, in this case, the connection element that fixes the adjustment part on the slide element is fixed, after assembly of the door drive device as intended, on the one hand on the base portion at the fixing opening of the fixing insert, and on the other hand at the further fastening opening (e.g. directly on the base portion and without an additional insert). The further fastening opening and the fixing opening of the fixing insert can be provided opposite one another on the base portion and here in particular on two mutually opposing walls of the base portion, between which a portion, in particular an end, of the adjustment part with the through-opening for the connection element is present.

In a variant, the connection element is pressed in at the further fastening opening. In this case, e.g. to reduce preloads in the case of process-related higher tolerances between the connection element and the base portion, a region of the connection element pressed into the further fastening opening can be configured to be cylindrical and furthermore spherical, i.e. curved radially outwards at its outer periphery. A spherical portion of this kind is then for example pressed into the further fastening opening of the base portion, which may have a circular cross-section. Alternatively, the further pressed-in portion of the connection element can have a circular cylindrical shape and be pressed into the further fastening opening. In particular in the case of a circular cylindrical shape of the portion to be pressed in, the further fastening opening can also have an elliptical cross-section.

The proposed solution further relates to a vehicle door having a door drive device according to the proposed solution, and a vehicle having at least one such door drive device.

### BRIEF DESCRIPTION OF THE DRAWINGS

The accompanying figures illustrate, by way of example, possible variants of the proposed solution.

FIG. 1 is a partially sectional view of the door drive device according to the proposed solution.

FIG. 2 is a perspective view of a slide element of a transmission module of the door drive device of FIG. 1.

FIG. 3 is a partially sectional view of the slide element of FIG. 2.

FIG. 4 is a perspective view of a fixing insert of the slide element of FIG. 3.

FIG. 5A is a plan view of the slide element with a convexly curved end stop surface in an end stop position, in which the slide element strikes a mating element of the door drive device.

FIG. 5B is a view corresponding to FIG. 5A of an alternative variant, in which a convexly curved mating surface for the striking slide element is formed on the mating element.

FIG. 6A shows a variant in which a connection element for fixing an adjustment part of the door drive device on the slide element is configured having a spherical head portion as a first form-fitting portion.

FIG. 6B is a view corresponding to FIG. 6A of an alternative variant, in which a circular cylindrical head portion of the connection element is pressed into a fastening opening on the slide element with an elliptical cross-section.

FIG. 7 is a schematic view of a vehicle door on a vehicle body, comprising an adjustment part in the form of a push rod, which is hingedly arranged on the vehicle body and moves relative to the vehicle door when the vehicle door is pivoted, according to the variant of a door drive device of FIG. 1.

FIG. 8A is a side view of the door drive device with the adjustment part in a retracted position.

FIG. 8B is a plan view of the door drive device of FIG. 8A.

FIGS. 9A-9B are views, corresponding to FIGS. 8A and 8B, of the door drive device with the adjustment part in an extended position.

### DETAILED DESCRIPTION

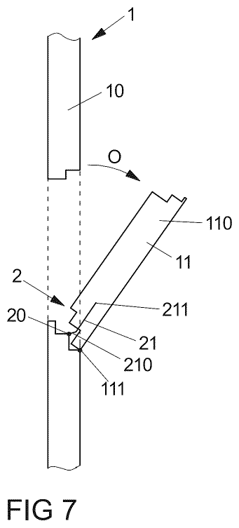

FIG. 7 is a schematic view of a vehicle 1 comprising a vehicle body 10 and a vehicle door 11 which is hingedly arranged on the vehicle body 10 about a door hinge 111 and which can be pivoted relative to the vehicle body 10 along an opening direction O in order to release or to close a door opening.

A door drive device 2 acts between the vehicle body 10 and the vehicle door 11, which door drive device comprises an adjustment part in the form of a push element, in the present case by way of example a push rod 21, and serves for adjusting the vehicle door 11 relative to the vehicle body 10. The push rod 21 is hingedly arranged, at a first end 210, on the vehicle body 10, for example on the A-pillar of the vehicle 1, via a joint 20, and moves relative to the vehicle door 11 when the vehicle door 11 is pivoted. For this purpose, the adjustment part 21 projects with a second end 211 into a door interior 110 of the vehicle door 11 and moves into said door interior 110 when the vehicle door 11 is adjusted.

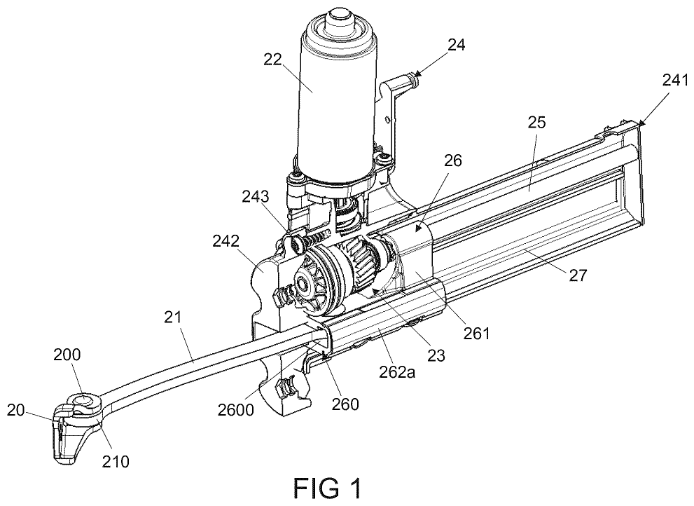

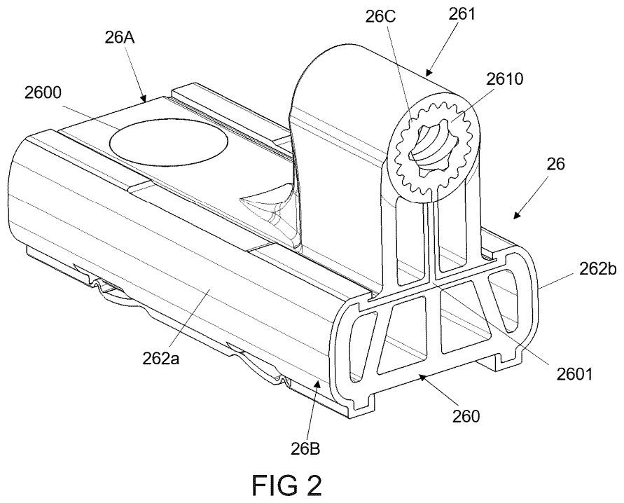

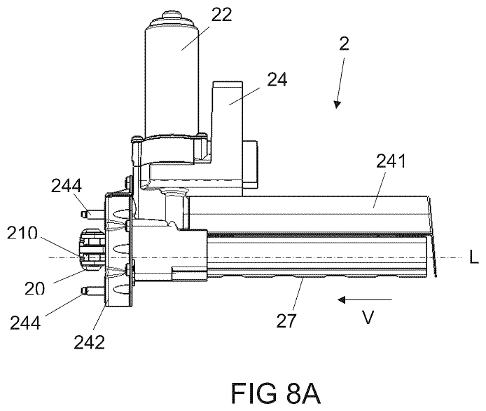

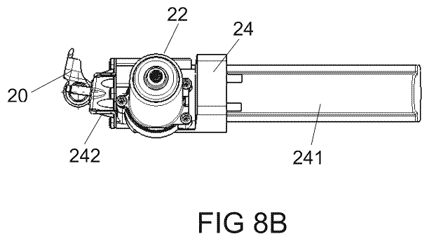

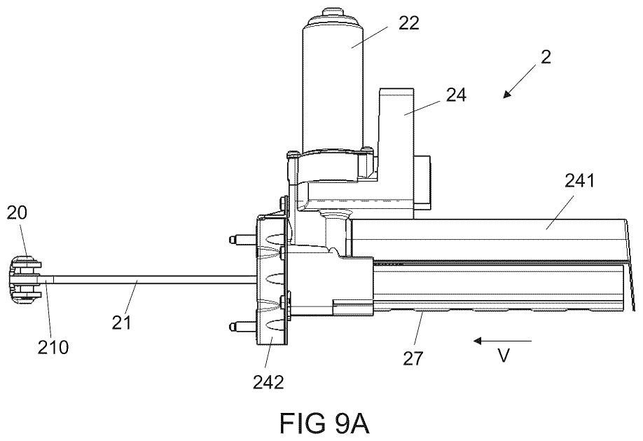

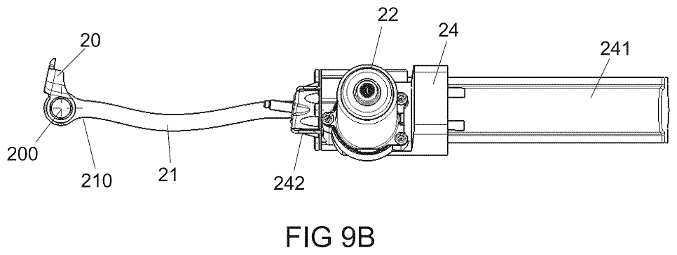

FIGS. 1 to 6B and 8A to 9B are views of an embodiment of the door drive device 2 which serves for adjusting an adjustment part, such as the push rod 21, and thereby for moving the vehicle door 11 relative to the vehicle body 10. In this case, FIGS. 8A, 8B, 9A and 9B are side views and plan views of the door drive device 2 in different end positions of the push rod 21, while FIG. 1 is a partially sectional view of the door drive device 2 in the extended position of the push rod 21, visible in FIGS. 9A and 9B. FIGS. 2 to 6B show details of a slide element 26 of the door drive device 2.

Said slide element 26 is displaceably mounted on a guide element of the door drive device 2 in the form of a guide rail 27. In this case, the guide rail 27 is received inside a transmission housing 24 of the door drive device 2. The slide element 26 rests in a sliding manner on the guide rail 27 such that the slide element 26 can be adjusted longitudinally on the guide rail 27, along an adjustment direction V. In the present case, the guide rail 27 is C-shaped in a cross-section transversely to the adjustment direction V, which C-shape is formed by a base and limbs extending laterally on the base and angled relative to the base, the edges of which remote from the base are bent such that they face towards one another. The slide element 26 is guided in the guide rail 27 in such a way that the slide element 26 is received between the limbs and is peripherally surrounded by the base, the limbs, and the bent edges of the guide rail 27.

In the embodiment shown, the guide rail 27 is formed as a bent sheet metal part and is rigidly connected to the transmission housing 24 via an adapter part in the form of a fastening plate 242 and portions resting on the transmission housing 24. The fastening plate 242 is connected to the transmission housing 24 via fastening elements 243 in the form of screws, and can be fixed to a structural portion of the vehicle door 11, for example to an interior door panel portion, via fastening elements 244 in the form of screws, such that the door drive device 2 is thereby fixed in the vehicle door 11.

For adjusting the push rod 21 coupled to the slide element 26, the transmission module 23 in particular comprises a drive spindle 25 which meshes with a spindle nut of the slide element 26. Said spindle nut is formed on a spindle nut portion 261 of the slide element 26. FIGS. 8A to 9B said spindle nut portion 261 of the slide element and the guide rail 27 are covered towards the outside by a cover element 241 of the transmission housing 24.

The push rod 21 is hingedly coupled to a first joint 20, via a knuckle joint 200 at the first end 210, about a joint axis, which joint is rigidly connected to the vehicle body 10, as is shown schematically in FIG. 7. At the second end 211, remote from the first end 210, the push rod 21 is hingedly coupled to the slide element 26. In the present case, the push rod 21 can-on account of the configuration of the door drive device 2—be configured having a comparatively uncomplicated geometry, and for example extends virtually in a straight line between the respectively hinged ends 210 and 211. By adjusting the slide element 26, driven by the drive motor 22, the second end 211 of the push rod 21 can be moved on the guide rail 27, such that the push rod 21 can be adjusted between a first, retracted position (FIGS. 8A and 8B) and a second, extended position (FIGS. 9A and 9B), in order to move the vehicle door 11 relative to the vehicle body 10 and to adjust it between a closed position (corresponding to the retracted position of the push rod 21) and an open position (corresponding to an extended position of the push rod 21).

In the first, retracted position the slide element 26 is removed from the transmission housing 24 and moved towards an end of the guide rail 27 remote from the fastening plate 242. In the second, extended position the slide element 26 is, in contrast, moved towards the transmission housing 24 such that the spindle nut portion 261 is moved towards the transmission 23 and the second end 211 of the push rod 21 is moved in the adjustment direction V, to the fastening plate 242.

In this case, in the second position the slide element 26 plunges under the transmission 23 with a base portion 260, in that the slide element 26, viewed along the adjustment direction V, comes into axial overlap with the transmission housing 24 and the transmission 23 received thereon, as can be seen from FIG. 1. This allows for a structure of the drive device 2 which is efficient in terms of construction space, with a comparatively significant lift of the push rod 21 along the adjustment direction V and small installation height transversely to the adjustment direction V, in particular perpendicularly along the joint axis of the joint 20.

In the case of the slide element 26, the base portion 260 and the spindle nut portion 261 protruding (upwards) thereon are formed from a fiber-reinforced plastics material. In this case, the base portion 260 and the spindle nut portion 261 are part of a structural part 26A of the slide element 26, which is configured as a hard component. For this purpose, for example fiber-reinforced, e.g., glass fiber-reinforced, polyamide is used for forming the structural part 26A.

As is illustrated in particular in the perspective view of the slide element 26 in FIG. 2, slide regions 262a, 262b, via which the slide element 26 rests on the guide rail 27, and a coating of a spindle nut thread 2610 of the spindle nut portion 261 made of a different material having better tribological properties are formed on the slide element 26. For example, POM can be used here. Therefore, in this case, POM is injected onto the structural part 26A for forming the slide regions 262a and 262b on the longitudinal side surfaces of the base shoulder 260 and for forming a coating for the spindle nut thread 2610 formed by the spindle nut portion 261. In this case, the slide regions 262a and 262b can be provided as an outer overmolding or overspraying 26B on the base portion 260. The coating of the spindle nut thread 2610 is turn configured as an inner overmolding or overspraying 26C.

In order to simplify the application of the POM material in the production process, within a production mold, a connecting channel 2601 is formed in the structural part 26A, which channel connects the spindle nut portion 261 to the base portion 260 and via which channel the POM material, which is still liquid during production of the slide element 261, can flow from the spindle nut portion 261 to the base portion 260 or from the base portion 260 to the spindle nut thread 2610.

Furthermore, a connection region in the form of a connection opening 260 is formed on the base portion 260, at which connection region the second end 211 of the push rod 21 can be fixed on the slide element 26. In this case, the second end 211 of the push rod 21 is configured having a (connecting) eye and can be introduced into the connection opening 2600, such that the eye of the push rod 21 is present in the base portion 260 between two walls configured having fastening openings 2600A and 2600B.

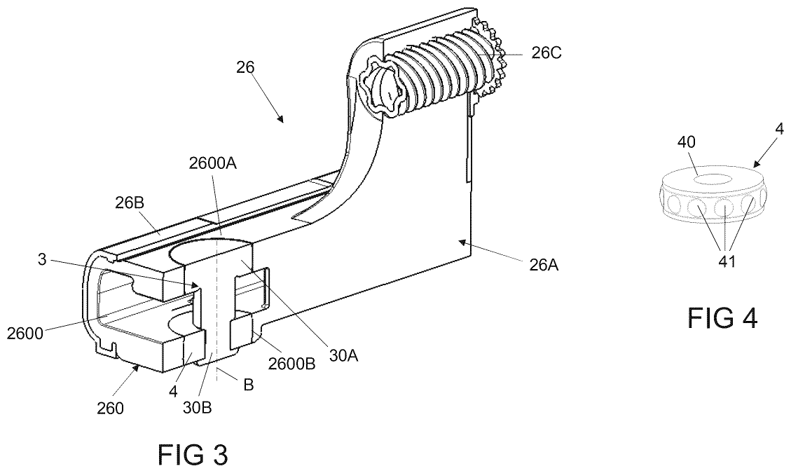

The push rod 21 is fixed on the slide element and hinged thereto via connecting bolts 3 which engage in the fastening openings 2600A and 2600B and penetrate the eye of the push rod 21 (cf. FIGS. 1, 3, 6A and 6B). The head portion of the connecting bolt 3 is pressed, as a first form-fitting portion 30A, into a first, here upper, fastening opening 2600A. A shank portion, which forms a second form-fitting portion 30B of the connecting bolt 3, is in turn pressed into a fixing insert 4 of the base portion 260 at the opposite, second fastening opening 2600B. The fixing insert 4 is visible in the sectional view of FIG. 3 and is shown in a detailed view in FIG. 4.

The fixing insert 4 comprises a fixing opening 40, into which the connecting bolt 3 is pressed with the end of its shank (to which the second end 211 is hinged) with the shank portion 30B along an axis B extending transversely to the adjustment direction V, which axis extends in parallel with a longitudinal extension direction of the connecting bolt 3. In the present case, the fixing insert 4 is configured in the shape of a circular disc and comprises equidistantly distributed projections 41, here by way of example in the shape of spherical segments, on its outer periphery. The projections 41 protrude radially outwards on the fixing insert 4, with respect to the axis B, and project into the fiber-reinforced plastics material of the base portion 260. In this way, the fixing insert 4 is embedded into the plastics material of the base portion 260 and secured therein in a form-fitting manner. In the production of the base portion, the fixing insert 4 is laid in the production die for the slide element 26 and subsequently overmolded with the fiber-reinforced plastics material of the structural part 26A.

In a further development, the connecting bolt 3 and the fixing insert 4, which is discoid here, are in each case received the base portion 260 in a form-fitting manner in opposite directions. In this case, then for example the connecting bolt 3 can be secured downwards and the fixing insert 4 can be secured upwards, in a form-fitting manner, on the base portion 260. In this way, for example, overmolding of the fixing insert with the material of the base portion 260 can be saved.

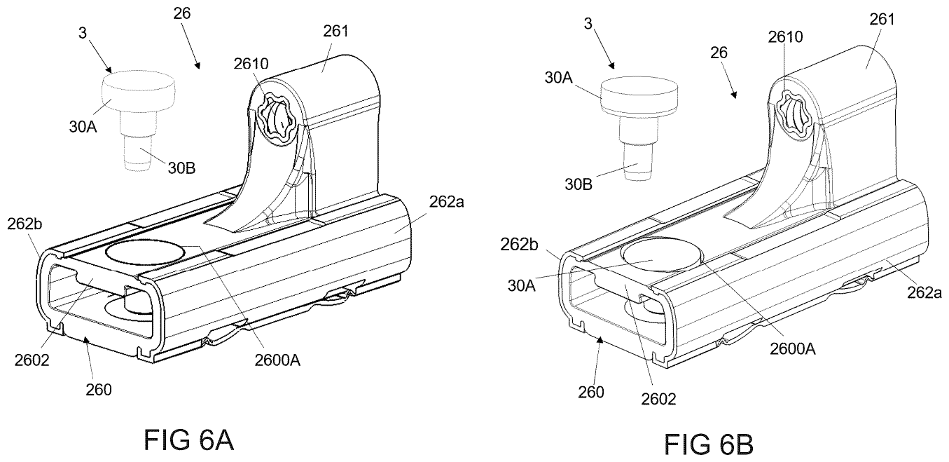

For further improving the clearance-free fixing of the connecting bolt 3 to the base portion 260, a possible development according to FIG. 6A provides that the cylindrical head portion 30A is configured spherically for pressing into the (upper) fastening opening 2600A formed by the structural part 26A. Here, the spherical head portion 30A of the connecting bolt 3 is pressed with a circular cross-section into a fastening opening 2600A of the base portion 260.

Alternatively thereto, the variant of FIG. 6B provides that the fastening opening 2600A is configured having an elliptical cross-section, and the head portion 30A is configured to be circular cylindrical.

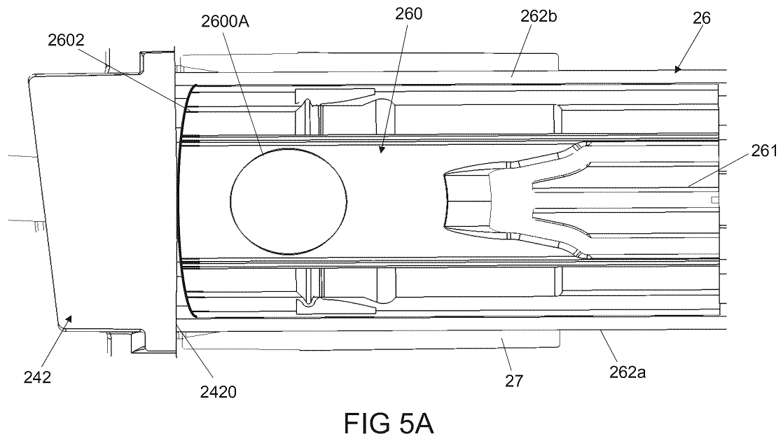

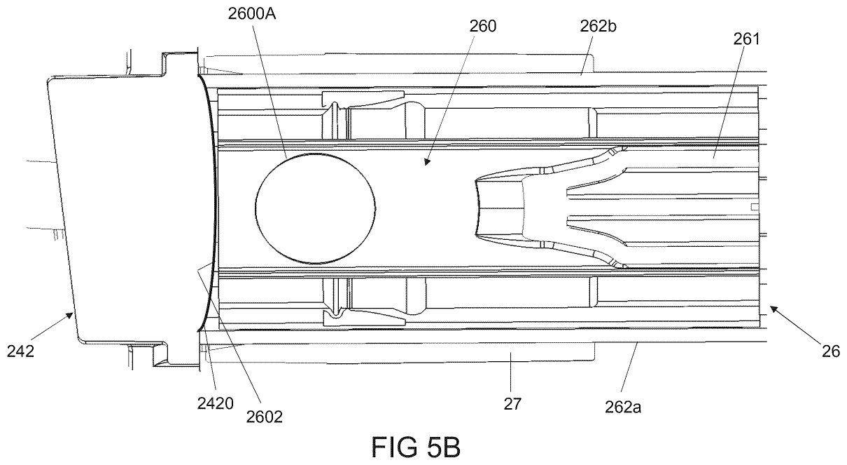

The use of fiber-reinforced plastics material for the structural part 26A also makes it possible to optimize an end stop surface 2602 of the slide element 26 with respect to the loading case, when the push rod 21 is extended to a maximum and strikes the fastening plate 242. Thus, the slide element 26 strikes a mating surface 2420 of the fastening plate 242 with the end stop surface 2602 that is located in the adjustment direction V, when the vehicle door 1 assumes a maximally open position. Due to the striking, comparatively high forces act, which must be absorbed by the slide element 26. Against this background, in the variant shown in FIG. 5A, the end stop surface 2602 of the slide element 26 formed by the structural part 26A is convexly curved in the direction of the fastening plate 242.

In an alternative variant corresponding to FIG. 5B, the mating surface 2420 of the fastening plate 242 is convexly curved in the direction of the slide element 26.

The door drive device 2 can, as illustrated in FIGS. 1 to 9B, be installed in a vehicle door 11 with a drive motor 22 projecting upwards, but also with a drive motor 22 projecting downwards. In this case, the drive motor 22 can also be arranged at an end of the guide rail 27 which faces away from the end of the guide rail 27 at which the adjustment part 21 emerges from the guide rail 27. As a result, the drive device 2 can be used universally on different door models of different vehicles.

The concept on which the proposed solution is based is not limited to the embodiments set out above but rather can also be implemented in entirely different embodiments.

A door drive device of the described type can in particular be used on a vehicle side door, such as a tailgate, or also on another vehicle opening.

### LIST OF REFERENCE SIGNS

1 Vehicle
10 Body
11 Vehicle door
110 Door interior
111 Door hinge
2 Door drive device
200 Knuckle joint
21 Push rod (adjustment part)
210 1st end
211 2nd end
22 Drive motor
23 Transmission module
24 Transmission housing
241 Cover element
242 Fastening plate (adapter part)
2420 Mating surface
243 Fastening element
244 Fastening element
25 Drive spindle
26 Slide element
260 Base portion
2600 Connection opening
2600A, 2600B Fastening opening
2601 Connecting channel
2602 End stop surface
261 Spindle nut portion
2610 Spindle nut thread
262a, 262b Slide region
26A Structural part
26B Outer overmolding
26C Inner overmolding
27 Guide rail (guide element)
3 Connecting bolt
30A Head portion (1st form-fitting portion)
30B Shank portion (2nd form-fitting portion)
4 Fixing insert
40 Fixing opening
41 Projection
B Axis
L Longitudinal axis
O Opening direction
V Adjustment direction

1. A door drive device for adjusting a vehicle door relative to a vehicle body, comprising
an adjustment part for force transmission between the vehicle door and the vehicle body,
a drive motor, and
a transmission module that couples the drive motor to the adjustment part,
wherein the transmission module comprises at least one guide element and a slide element which is coupled to the adjustment part and is guided along an adjustment direction, on the guide element, and via which the drive motor is adjustable, and
wherein the slide element is formed with a structural part made of fiber-reinforced plastics material, and at least one slide region for sliding contact on the guide element is arranged on the structural part, which slide region is formed of a material that is different from the fiber-reinforced plastics material of the structural part.

2. The door drive device according to claim 1, wherein the at least one slide region consists of polyoxymethylene.

3. The door drive device according to claim 1, wherein the at least one slide region is injected onto the structural part formed of fiber-reinforced plastics material or is fastened to the structural part formed of fiber-reinforced plastics material.

4. A door drive device for adjusting a vehicle door relative to a vehicle body, comprising
an adjustment part for force transmission between the vehicle door and the vehicle body,
a drive motor, and
a transmission module that couples the drive motor to the adjustment part,
wherein the transmission module comprises at least one guide element and a drive spindle which can be driven by the drive motor, as well as a slide element which is coupled to the adjustment part and is adjustable along an adjustment direction upon rotation of the drive spindle, and
wherein the slide element is formed with a structural part made of fiber-reinforced plastics material, wherein a spindle nut portion having a spindle nut thread for meshing with the drive spindle is formed on the structural part, and a material different from the fiber-reinforced plastics material of the structural part is arranged on the spindle nut thread.

5. The door drive device according to claim 4, wherein the material arranged on the spindle nut thread is polyoxymethylene.

6. The door drive device according to claim 4, wherein the material is injected onto the spindle nut thread.

7. The door drive device according to claim 1, wherein the slide element is coupled to the adjustment part and is adjustable along the adjustment direction upon rotation of a drive spindle, wherein a spindle nut portion having a spindle nut thread for meshing with the drive spindle is formed on the structural part, and a material different from the fiber-reinforced plastics material of the structural part is arranged on the spindle nut thread, wherein the slide region is arranged on a base portion of the structural part, the material for forming the at least one slide region is also arranged on the spindle nut thread and at least one connecting channel is formed in the structural part, via which channel, during production of the at least one slide region the then still liquid material can flow onto the spindle nut thread, or via which the then still liquid material can flow to the base portion, upon arrangement of the material on the spindle nut thread, for forming the at least one slide region.

8. The door drive device according to claim 1, wherein the structural part of the slide element comprises an end stop surface which strikes a mating element of the door drive device at the end of an adjustment path for the vehicle door, and is convexly curved in the direction of the mating element.

9. The door drive device according to claim 1, wherein the structural part of the slide element comprises an end stop surface which strikes a mating surface of a mating element of the door drive device at the end of an adjustment path for the vehicle door, and the mating surface is convexly curved in the direction of the slide element.

10. A door drive device for adjusting a vehicle door relative to a vehicle body, comprising
an adjustment part for force transmission between the vehicle door and the vehicle body,
a drive motor, and
a transmission module that couples the drive motor to the adjustment part,
wherein the transmission module comprises at least one guide element and a slide element which is coupled to the adjustment part and is guided along an adjustment direction, on the guide element, and via which the drive motor is adjustable,
wherein the slide element comprises a base portion on which a connection region for coupling of the adjustment part to the slide element is formed and on which at least one fastening opening for a connection element is formed, wherein the adjustment part is fixed on the slide element via the connection element in that the connection element engages through a through-opening on the adjustment part transversely to the adjustment direction, and
wherein at the at least one fastening opening, a fixing insert is received in the base portion of the slide element in at least one of a form-fitting manner and a force-fitting manner, which fixing insert comprises a fixing opening in which a portion of the connection element is fixed.

11. The door drive device according to claim 10, wherein the connection element and the fixing insert are secured on the base portion in a form-fitting manner in opposite directions along an axis extending through the fastening opening.

12. The door drive device according to claim 10, wherein the fixing insert is received in a fiber-reinforced plastics material, from which the base portion is formed.

13. The door drive device according to claim 10, wherein the fixing insert comprises at least one projection for establishing a form-fitting connection with the base portion, which projection protrudes radially towards the outside with respect to an axis extending transversely to the adjustment direction.

14. The door drive device according to claim 13, wherein the fixing insert comprises a plurality of racially protruding projections that are distributed over an outer periphery.

15. The door drive device according to claim 10, wherein the base portion comprises a further fastening opening, in addition to the fastening opening that receives the fixing insert, in which further fastening opening a further portion of the connection element is received in at least one of a form-fitting manner and a force-fitting manner.

16. The door drive device according to claim 15, wherein the connection element is pressed in at the further fastening opening, wherein
a) the further fastening opening has a circular cross-section and a region of the connection element pressed into the further fastening opening is configured to be cylindrical and spherical, or
b) the further fastening opening has an elliptical cross-section and a region of the connection element pressed into the further fastening opening is of a circular cylindrical shape.

17. (canceled)

18. The door drive device according to claim 4, wherein the structural part of the slide element comprises an end stop surface which strikes a mating element of the door drive device at the end of an adjustment path for the vehicle door, and is convexly curved in the direction of the mating element.

19. The door drive device according to claim 4, wherein the structural part of the slide element comprises an end stop surface which strikes a mating surface of a mating element of the door drive device at the end of an adjustment path for the vehicle door, and the mating surface is convexly curved in the direction of the slide element.
